(19) United States
(12) Patent Application Publication
(10) Pub. No.: US 2025/0005239 A1
(43) Pub. Date: Jan. 2, 2025

(54) INFORMATION PROCESSING METHOD, INFORMATION PROCESSING DEVICE, AND NON-TRANSITORY COMPUTER READABLE RECORDING MEDIUM STORING INFORMATION PROCESSING PROGRAM

(71) Applicant: Panasonic Intellectual Property Corporation of America, Torrance, CA (US)

(72) Inventors: Yasuyuki SOFUE, Osaka (JP); Masashi OKADA, Osaka (JP)

(21) Appl. No.: 18/810,756

(22) Filed: Aug. 21, 2024

Related U.S. Application Data
(63) Continuation of application No. PCT/JP2022/048513, filed on Dec. 28, 2022.
(60) Provisional application No. 63/312,682, filed on Feb. 22, 2022.

(30) Foreign Application Priority Data
Oct. 24, 2022 (JP) 2022-169951

(51) Int. Cl. G06F 30/27; G06F 119/02

(52) U.S. Cl. CPC G06F 30/27; G06F 2119/02

(57) ABSTRACT

An information processing device: acquires a feature quantity indicating a feature of a measurement target measured by a sensor; predicts a state of the measurement target by inputting the feature quantity into a machine learning model; acquires a plurality of design parameter modification methods to improve state prediction accuracy of the machine learning model and modify a design parameter of the sensor; determines an optimum design parameter modification method from among the plurality of design parameter modification methods based on the feature quantity and a prediction result of the state; and outputs the optimum design parameter modification method determined.

### FIELD OF INVENTION

The present disclosure relates to a technology to optimize design parameters for developing sensors.

### BACKGROUND ART

Conventionally, when the state of a measurement target of a developed sensor is discriminated by a machine learning model, parameters of the machine learning model are optimized.

For example, the analysis device in Patent Literature 1 acquires an analysis result analyzed by an analysis model that analyzes a target event by using a plurality of parameters, evaluates combinations of the plurality of parameters by the Bayesian optimization method based on the analysis results acquired when the target event is analyzed by the analysis model, and determines the parameter combination for the analysis model from among the plurality of parameter combinations based on evaluation results for each evaluated combination of the plurality of parameters.

For example, the machine learning device in Patent Literature 2 learns a learning target by acquiring basic learning information including basic learning results from the outside and tuning the acquired basic learning information. The machine learning device tunes the basic learning information by performing first active learning using a pre-prepared teacher dataset, determines whether image processing is required for each image based on the teacher dataset, generates a processed image by performing necessary image processing on each image that is determined to require image processing, and tunes the basic learning information by performing second active learning using image data of each generated processed image as teacher data.

However, while the above-described conventional technology can optimize the machine learning model, but does not mention optimizing the feature quantity that is input into the machine learning model, and further improvements are needed.
Patent Literature 1: JP 2019-215750 A
Patent Literature 2: JP 6861124 B2

### SUMMARY OF THE INVENTION

The present disclosure has been made to solve the above problems, and an object of the present disclosure is to provide a technology to optimize the feature quantity that is input into the machine learning model.

An information processing method according to the present disclosure is an information processing method in a computer, and includes: acquiring a feature quantity indicating a feature of a measurement target measured by a sensor; predicting a state of the measurement target by inputting the feature quantity into a machine learning model; acquiring a plurality of design parameter modification methods to improve state prediction accuracy of the machine learning model and modify a design parameter of the sensor; determining an optimum design parameter modification method from among the plurality of design parameter modification methods based on the feature quantity and a prediction result of the state; and outputting the optimum design parameter modification method determined.

According to the present disclosure, the feature quantity that is input into the machine learning model can be optimized.

### BRIEF DESCRIPTION OF THE DRAWINGS

FIG. 1 is a diagram for describing an example of development aimed at improving the discrimination accuracy about whether a viral infection is positive or negative in an antigen test sensor.

FIG. 2 is a diagram showing a configuration of a sensor development system in an embodiment of the present disclosure.

FIG. 3 is a block diagram showing a configuration of a modification method determination part in the present embodiment.

FIG. 4 is a first flowchart for describing the design parameter optimization process of an information processing device in the embodiment of the present disclosure.

FIG. 5 is a second flowchart for describing the design parameter optimization process of the information processing device in the embodiment of the present disclosure.

FIG. 6 is a schematic diagram for describing calculation of the design parameter in the present embodiment.

FIG. 7 is a schematic diagram for describing calculation of a prediction error in the present embodiment.

FIG. 8 is a schematic diagram for describing calculation of a modification cost value in the present embodiment.

FIG. 9 is a diagram showing one example of flower type classes, feature quantities, design parameters, and development cost coefficients in this experiment.

FIG. 10 is a diagram showing one example of a design parameter modification method based on results of the design parameter optimization process in the first condition to the fifth condition.

FIG. 11 is a schematic diagram for describing calculation of the modification cost value in a modified example of the present embodiment.

### DETAILED DESCRIPTION

### (Knowledge Underlying Present Disclosure)

The above-described Patent Literature 1 describes the optimization of an analysis model, but does not consider tuning of teacher data.

Meanwhile, the above-described Patent Literature 2 refers not only to the optimization of a learning model but also to the generation of teacher data in order to improve the accuracy of the learning model. That is, Patent Literature 2 discloses that image data of each processed image generated by applying the necessary image processing to each image is used as the teacher data. However, Patent Literature 2 does not consider the optimization of sensor design parameters to acquire the teacher data, and it is difficult to acquire the teacher data to implement a more accurate learning model.

To solve the above problems, the following technology is disclosed.

(1) An information processing method according to one aspect of the present disclosure is an information processing method in a computer, and includes: acquiring a feature quantity indicating a feature of a measurement target measured by a sensor; predicting a state of the measurement target by inputting the feature quantity into a machine learning model; acquiring a plurality of design parameter modification methods to improve state prediction accuracy of the machine learning model and modify a design parameter of the sensor; determining an optimum design parameter modification method from among the plurality of design parameter modification methods based on the feature quantity and a prediction result of the state; and outputting the optimum design parameter modification method determined.

With this configuration, from among the plurality of design parameter modification methods to improve the state prediction accuracy of the machine learning model and modify the sensor design parameter, the optimum design parameter modification method is determined, and the determined optimum design parameter modification method is output. Therefore, the sensor design is modified by the sensor developer by using the output optimum design parameter modification method, thereby enabling the feature quantity input into the machine learning model to be optimized. In addition, the machine learning model is trained using the optimized feature quantity, thereby improving the accuracy of the machine learning.

(2) In the information processing method according to (1) described above, determining the optimum design parameter modification method may include: calculating a modification amount of the design parameter for each of the plurality of design parameter modification methods based on the feature quantity and the prediction result of the state; and specifying the optimum design parameter modification method from among the plurality of design parameter modification methods based on the modification amount.

With this configuration, the optimum design parameter modification method is specified from among the plurality of design parameter modification methods based on the design parameter modification amount for each of the plurality of design parameter modification methods. Therefore, for example, the design parameter modification method that minimizes the design parameter modification amount can be specified as the optimum design parameter modification method.

(3) The information processing method according to (2) described above may further include determining, based on the prediction result of the state and a correct answer state corresponding to the feature quantity input in the machine learning model, whether the prediction result of the state is the correct answer state, in which determining the optimum design parameter modification method may further include: calculating the design parameter for each of the plurality of design parameter modification methods; and calculating, as a prediction error, a distance between a wrong answer point of the feature quantity corresponding to the prediction result determined not to be the correct answer state on a feature quantity space, and a correct answer point of the feature quantity corresponding to the prediction result determined to be the correct answer state on the feature quantity space, and calculating the modification amount of the design parameter may include calculating the modification amount on the design parameter space based on the calculated prediction error and the calculated design parameter.

With this configuration, the wrong answer point moves to the position of the correct answer point on the feature quantity space, whereby the prediction result of an incorrect answer state changes to the correct answer state. Therefore, the modification amount on the design parameter space can be calculated from the prediction error that is the distance between the wrong answer point and the correct answer point.

(4) In the information processing method according to (2) or (3) described above, determining the optimum design parameter modification method may further include: acquiring a development cost coefficient that is set for each of the plurality of design parameter modification methods and is set according to a cost required to develop the sensor; and calculating a modification cost value for each of the plurality of design parameter modification methods by multiplying the modification amount for each of the plurality of design parameter modification methods by the development cost coefficient for each of the plurality of design parameter modification methods, and specifying the optimum design parameter modification method may include specifying the design parameter modification method that minimizes the modification cost value calculated as the optimum design parameter modification method.

With this configuration, the modification cost value for each of the plurality of design parameter modification methods is calculated by multiplying the modification amount for each of the plurality of design parameter modification methods by the development cost coefficient for each of the plurality of design parameter modification methods. Then, the design parameter modification method that minimizes the calculated modification cost value is specified as the optimum design parameter modification method.

Here, design changes to the sensor require development costs, and the development costs differ depending on the design parameter modification method. Therefore, the design parameter modification method that minimizes the development cost is specified as the optimum design parameter modification method, thereby enabling reduction in the sensor development cost.

(5) In the information processing method according to (4) described above, determining the optimum design parameter modification method may further include multiplying the modification cost value for each of the plurality of design parameter modification methods by a correction coefficient, specifying the optimum design parameter modification method may include specifying the design parameter modification method that minimizes the modification cost value multiplied by the correction coefficient as the optimum design parameter modification method, predicting the state may include: predicting the state of the measurement target by inputting the feature quantity obtained from the sensor using the design parameter modified by the specified optimum design parameter modification method into the machine learning model; and determining whether the prediction result of the state is the correct answer state based on the prediction result of the state and the correct answer state corresponding to the feature quantity input into the machine learning model, and determining the optimum design parameter modification method may further include updating the correction coefficient when it is determined that the prediction result of the state is not the correct answer state.

With this configuration, the modification cost value for each of the plurality of design parameter modification methods is multiplied by the correction coefficient, and the correction coefficient is repeatedly updated until it is determined that the prediction result of the state is the correct answer state, thereby making it possible to further suppress the development cost.

(6) In the information processing method according to any one of (1) to (5) described above, the design parameter may be an average value of the distribution of the feature quantity, and the design parameter modification method may shift the average value of the distribution of the feature quantity.

With this configuration, by changing the sensor design to shift the average value of the distribution of the feature quantity, the feature quantity input into the machine learning model can be optimized.

(7) In the information processing method according to any one of (1) to (6) described above, the design parameter may be a standard deviation of the distribution of the feature quantity, and the design parameter modification method may shrink the standard deviation of the distribution of the feature quantity.

With this configuration, by changing the sensor design to shrink the standard deviation of the distribution of the feature quantity, the feature quantity input into the machine learning model can be optimized.

The present disclosure can be implemented not only as the information processing method for performing the characteristic process as described above, but also as an information processing device or the like having a characteristic configuration corresponding to the characteristic process performed by the information processing method. The present disclosure can also be implemented as a computer program that causes a computer to execute characteristic processing included in the information processing method described above. Therefore, even other aspects below can achieve an effect as in the above information processing method.

(8) An information processing device according to another aspect of the present disclosure includes: a feature quantity acquisition part that acquires a feature quantity indicating a feature of a measurement target measured by a sensor; a prediction part that predicts a state of the measurement target by inputting the feature quantity into a machine learning model; a modification method acquisition part that acquires a plurality of design parameter modification methods to improve state prediction accuracy of the machine learning model and modify a design parameter of the sensor; a modification method determination part that determines an optimum design parameter modification method from among the plurality of design parameter modification methods based on the feature quantity and a prediction result of the state; and an output part that outputs the optimum design parameter modification method determined.

(9) An information processing program according to another aspect of the present disclosure causes a computer to execute: acquiring a feature quantity indicating a feature of a measurement target measured by a sensor; predicting a state of the measurement target by inputting the feature quantity into a machine learning model; acquiring a plurality of design parameter modification methods to improve state prediction accuracy of the machine learning model and modify a design parameter of the sensor; determining an optimum design parameter modification method from among the plurality of design parameter modification methods based on the feature quantity and a prediction result of the state; and outputting the optimum design parameter modification method determined.

(10) A non-transitory computer-readable recording medium according to another aspect of the present disclosure records an information processing program, and the information processing program causes a computer to execute: acquiring a feature quantity indicating a feature of a measurement target measured by a sensor; predicting a state of the measurement target by inputting the feature quantity into a machine learning model; acquiring a plurality of design parameter modification methods to improve state prediction accuracy of the machine learning model and modify a design parameter of the sensor; determining an optimum design parameter modification method from among the plurality of design parameter modification methods based on the feature quantity and a prediction result of the state; and outputting the optimum design parameter modification method determined.

Embodiments of the present disclosure will be described below with reference to the accompanying drawings. Note that each of the embodiments to be described below shows one specific example of the present disclosure. Numerical values, shapes, components, steps, order of steps, and the like shown in the embodiments below are merely one example, and are not intended to limit the present disclosure. Furthermore, a component that is not described in an independent claim representing the highest concept among components in the embodiments below is described as an arbitrary constituent. In all the embodiments, respective contents can be combined.

### Embodiment

In the development of a new sensor, machine learning is becoming widely used to discriminate the state of a measurement target from measurement values of the sensor. To increase the added value of the sensor, sensor developers will continue to develop the sensor to demonstrate more accurate state discrimination. There are two major development processes aimed at improving the accuracy of state discrimination.

The first one is the learning parameter optimization process of machine learning. This is the process of creating a learning model by using sensor measurement values acquired using the sensor under development as learning data and optimizing learning parameters to make the learning model more accurate. This process has been carried out conventionally, and methods for optimizing learning parameters and new learning models have already been proposed.

The second one is the sensor design parameter optimization process. This is the process of modifying the sensor design to obtain data more suitable for state discrimination when sufficient state discrimination accuracy is not obtained even if machine learning is performed based on data acquired from the sensor under development. This process is also performed in the development of sensors that do not use machine learning for state discrimination. For example, this process is performed in the development of antigen test sensors to detect specific viruses.

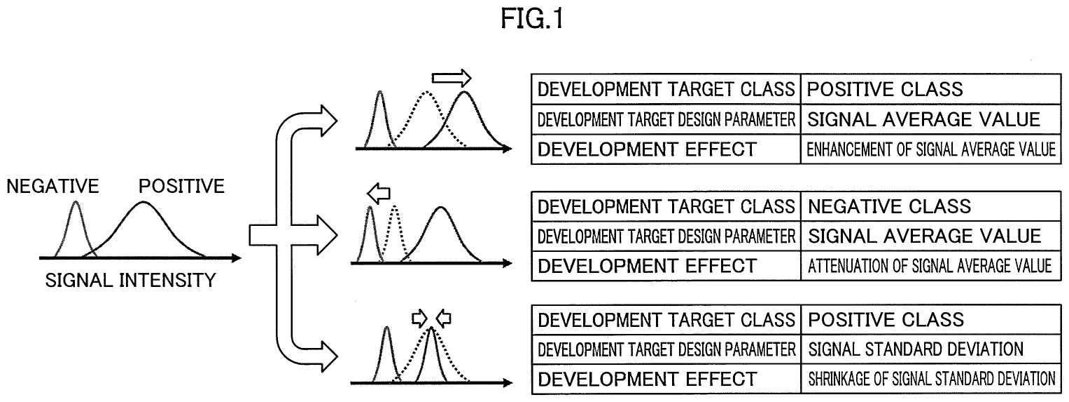

FIG. 1 is a diagram for describing an example of development aimed at improving the discrimination accuracy about whether a viral infection is positive or negative in an antigen test sensor.

As shown in FIG. 1, for example, when a portion of the distribution of signal intensity of a negative sample overlaps with a portion of the distribution of signal intensity of a positive sample, there is a risk that sufficient state discrimination accuracy may not be obtained.

Therefore, the following methods can be considered for the development of the antigen test sensor.

(1) A sensor that increases the binding rate of antibodies to target antigens is developed, thereby shifting the signal intensity average value for positive samples to higher values (upper right example in FIG. 1).

(2) A sensor that enhances the reaction selectivity of antibodies is developed, thereby shifting the signal intensity average value of substances other than the target antigen contained in negative samples (substances with a similar structure to the target, and the like) to lower values (upper middle example in FIG. 1).

(3) A new packaging method that suppresses the decline in reproducibility of antibody response strength due to aging or the like is developed, thereby shrinking the variance range of signal intensity for positive samples (lower right example in FIG. 1).

Developers of the antigen test sensor select an item with the lowest development cost (easy to develop) from among the above development items depending on the development status. This process corresponds to the sensor design parameter optimization process.

What the present disclosure focuses on is the development of a sensor that, unlike the antigen test sensor described above, uses a machine learning model for state discrimination. In this case, the design parameter optimization process is an expansion of the above-described development process to be performed for each of a plurality of feature quantities. The antigen test sensor has only one signal channel, which means in terms of machine learning, there is only one feature quantity. In contrast, for a sensor that has a plurality of channels and inputs the channels as feature quantities into a machine learning model, there are development method options like those described above for each feature quantity. In the design parameter optimization process, the development method to minimize the development cost is selected from all of the development methods.

The development cost value used in the design parameter optimization process is related to the numerical value of the development effect required by the sensor development. In the above example, as the required shift in the signal intensity average value increases, the development cost also increases. Therefore, to calculate the development cost value, a development cost coefficient is used to multiply the development effect amount. The development cost coefficient exists for each development item of each feature quantity, and all the development cost coefficients are not necessarily the same. The development cost coefficient is set depending on the status of the sensor under development or the development environment. For example, for a development item that is very difficult or impossible to implement, the development cost coefficient with a very large value is set.

Two development processes for sensor development are listed: the learning parameter optimization process and the design parameter optimization process. These processes are not competitive, and sensor developers alternate between both processes iteratively. Sensor development is performed by alternating between machine learning and sensor design revisions. The design parameter optimization process is a very important element in sensor development. By utilizing the design parameter optimization process, it is possible to perform highly accurate state discrimination that is impossible using only the learning parameter optimization process. However, there is previously no method for implementing the design parameter optimization process.

The present disclosure proposes a method for implementing the design parameter optimization process that has a plurality of channels and can be widely applied to sensor development on the precondition that uses machine learning to perform state determination.

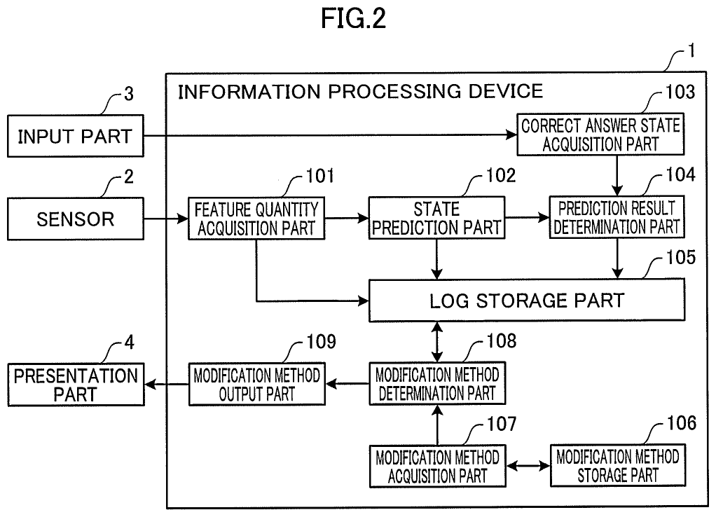

FIG. 2 is a diagram showing a configuration of a sensor development system in the embodiment of the present disclosure.

The sensor development system shown in FIG. 2 includes an information processing device 1, a sensor 2, an input part 3, and a presentation part 4.

The sensor 2 is a sensor to be developed. The sensor 2 outputs measurement data of at least one channel. The sensor 2 is, for example, an antigen test sensor that outputs measurement data of one channel, or an odor sensor that outputs measurement data of multiple channels.

The input part 3 is, for example, a keyboard, a mouse, and a touch panel. The input part 3 accepts an input of the correct answer state of the measurement target measured by the sensor 2 from a user (developer).

The information processing device 1 includes a feature quantity acquisition part 101, a state prediction part 102, a correct answer state acquisition part 103, a prediction result determination part 104, a log storage part 105, a modification method storage part 106, a modification method acquisition part 107, a modification method determination part 108, and a modification method output part 109.

Note that the feature quantity acquisition part 101, the state prediction part 102, the correct answer state acquisition part 103, the prediction result determination part 104, the modification method acquisition part 107, and the modification method output part 109 are implemented by a processor. The processor includes, for example, a central processing unit (CPU) or the like.

The log storage part 105 and the modification method storage part 106 are implemented by a memory. The memory includes, for example, a read only memory (ROM), an electrically erasable programmable read only memory (EEPROM), or the like.

The modification method determination part 108 is implemented by a processor and a memory.

Note that the information processing device 1 may be, for example, a computer or a server.

The information processing device 1 is connected to the sensor 2 communicably with each other in a wired or wireless manner.

The feature quantity acquisition part 101 acquires the feature quantity indicating the feature of the measurement target measured by the sensor 2. The sensor 2 converts raw data obtained by measuring the measurement target into the feature quantity and outputs the feature quantity to the information processing device 1. Note that the sensor 2 may output the raw data obtained by measuring the measurement target to the information processing device 1. In this case, the feature quantity acquisition part 101 acquires the feature quantity by converting the raw data output from the sensor 2 into the feature quantity. The feature quantity acquisition part 101 outputs the acquired feature quantity to the state prediction part 102 and the log storage part 105.

The state prediction part 102 predicts the state of the measurement target by inputting the feature quantity acquired by the feature quantity acquisition part 101 into the machine learning model. The state prediction part 102 discriminates whether the measurement target is in either a first state or a second state. The machine learning model undergoes machine learning by using the feature quantity as input data and the state of the measurement target as output data, to output the state of the measurement target when the feature quantity is input. The machine learning model is generated, for example, by light gradient boosting machine (GBM). The machine learning model may be generated, for example, by deep learning. The state prediction part 102 outputs the state prediction result to the prediction result determination part 104 and the log storage part 105.

Note that the state prediction part 102 may acquire the pre-trained machine learning model stored in advance in a memory. Additionally, the information processing device 1 may include a learning part. The learning part may learn the machine learning model by using the feature quantity acquired by the feature quantity acquisition part 101 and the correct answer state of the measurement target acquired by the correct answer state acquisition part 103 as the teacher data.

The correct answer state acquisition part 103 acquires the correct answer state corresponding to the feature quantity input into the machine learning model. The correct answer state acquisition part 103 acquires the correct answer state of the measurement target from the input part 3.

The prediction result determination part 104 determines whether the state prediction result is the correct answer state based on the state prediction result predicted by the state prediction part 102 and the correct answer state acquired by the correct answer state acquisition part 103. The prediction result determination part 104 outputs, to the log storage part 105, determination result information indicating whether the state prediction result is the correct answer state.

The log storage part 105 stores, as log information, the feature quantity acquired by the feature quantity acquisition part 101, the state of the measurement target predicted by the state prediction part 102, and the determination result information indicating whether the state prediction result determined by the prediction result determination part 104 is the correct answer state in association with one another. The log storage part 105 stores a plurality of pieces of log information.

The modification method storage part 106 stores in advance a plurality of design parameter modification methods to improve state prediction accuracy of the machine learning model and to modify the design parameter of the sensor 2. The design parameter is the average value of the distribution of the feature quantity or the standard deviation of the distribution of the feature quantity. When the design parameter is the average value of the distribution of the feature quantity, the design parameter modification method shifts the average value of the distribution of the feature quantity. That is, the design parameter modification method enhances or attenuates the average value of the distribution of the feature quantity. Meanwhile, when the design parameter is the standard deviation of the distribution of the feature quantity, the design parameter modification method shrinks the standard deviation of the distribution of the feature quantity.

The design parameter modification method includes a first design parameter modification method for increasing a first average value of the distribution of the feature quantity where the prediction result is the first state, a second design parameter modification method for reducing a second average value of the distribution of the feature quantity where the prediction result is the second state (second average value is smaller than the first average value), a third design parameter modification method for shrinking the first standard deviation of the distribution of the feature quantity where the prediction result is the first state, and a fourth design parameter modification method for shrinking the second standard deviation of the distribution of the feature quantity where the prediction result is the second state (second standard deviation is smaller than the first standard deviation).

The plurality of design parameter modification methods differs depending on the sensor 2. Therefore, the modification method storage part 106 stores the plurality of design parameter modification methods depending on the sensor 2 to develop.

Note that the above-described design parameter and the design parameter modification method are one example and are not limited to the above example.

The modification method acquisition part 107 acquires the plurality of design parameter modification methods for improving the state prediction accuracy of the machine learning model and modifying the design parameter of the sensor 2. The modification method acquisition part 107 acquires the plurality of design parameter modification methods from the modification method storage part 106.

The modification method determination part 108 determines the optimum design parameter modification method from among the plurality of design parameter modification methods based on the feature quantity acquired by the feature quantity acquisition part 101 and the state prediction result predicted by the state prediction part 102. The modification method determination part 108 calculates a design parameter modification amount for each of the plurality of design parameter modification methods based on the feature quantity and the state prediction result. The modification method determination part 108 specifies the optimum design parameter modification method from among the plurality of design parameter modification methods based on the design parameter modification amount. The modification method determination part 108 may specify the optimum design parameter modification amount from the design parameter modification amount for each of the plurality of design parameter modification methods.

The modification method output part 109 outputs the optimum design parameter modification method determined by the modification method determination part 108. The modification method output part 109 outputs the optimum design parameter modification method to the presentation part 4. In addition, the modification method output part 109 may output the optimum design parameter modification amount to the presentation part 4. Furthermore, the modification method output part 109 may output the feature quantity of a modification target and the state of the modification target to the presentation part 4.

The presentation part 4 presents the optimum design parameter modification method output by the modification method output part 109 to the user (developer). The presentation part 4 is, for example, a display device such as a liquid crystal display device. The presentation part 4 displays the optimum design parameter modification method. In addition, the presentation part 4 may present the optimum design parameter modification amount output by the modification method output part 109 to the user (developer). Furthermore, the presentation part 4 may present the feature quantity of the modification target and the state of the modification target to the user (developer).

Subsequently, the detailed configuration of the modification method determination part 108 shown in FIG. 2 will be described.

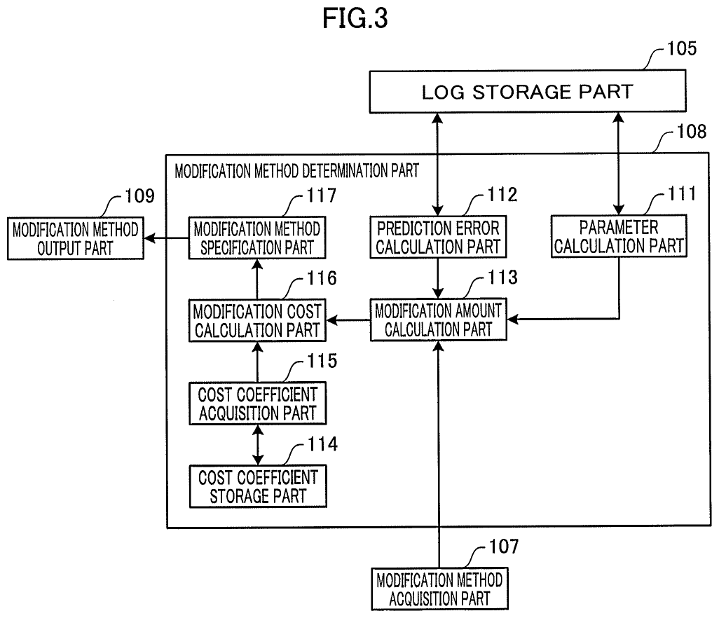

FIG. 3 is a block diagram showing the configuration of the modification method determination part 108 in the present embodiment.

The modification method determination part 108 includes a parameter calculation part 111, a prediction error calculation part 112, a modification amount calculation part 113, a cost coefficient storage part 114, a cost coefficient acquisition part 115, a modification cost calculation part 116, and a modification method specification part 117.

The parameter calculation part 111 calculates the design parameter for each of the plurality of design parameter modification methods. The parameter calculation part 111 calculates the average value of the distribution of the feature quantity where the prediction result is the first state as the design parameter for the first design parameter modification method. The parameter calculation part 111 calculates the average value of the distribution of the feature quantity where the prediction result is the second state as the design parameter for the second design parameter modification method. The parameter calculation part 111 calculates the standard deviation of the distribution of the feature quantity where the prediction result is the first state as the design parameter for the third design parameter modification method. The parameter calculation part 111 calculates the standard deviation of the distribution of the feature quantity where the prediction result is the second state as the design parameter for the fourth design parameter modification method.

The prediction error calculation part 112 calculates, as a prediction error, the distance between a wrong answer point on the feature quantity space of the feature quantity corresponding to the prediction result determined not to be the correct answer state by the prediction result determination part 104, and a correct answer point on the feature quantity space of the feature quantity corresponding to the prediction result determined to be the correct answer state by the prediction result determination part 104.

The modification amount calculation part 113 calculates the design parameter modification amount on the design parameter space based on the prediction error calculated by the prediction error calculation part 112 and the design parameter calculated by the parameter calculation part 111.

The cost coefficient storage part 114 stores in advance the development cost coefficient that is set for each of the plurality of design parameter modification methods and is set according to the cost required for development of the sensor 2. The cost coefficient storage part 114 stores the development cost coefficient for each of the plurality of design parameter modification methods.

The cost coefficient acquisition part 115 acquires the development cost coefficient that is set for each of the plurality of design parameter modification methods and is set according to the cost required for development of the sensor 2. The cost coefficient acquisition part 115 acquires the development cost coefficient corresponding to each of the plurality of design parameter modification methods from the cost coefficient storage part 114.

The modification cost calculation part 116 calculates a modification cost value for each of the plurality of design parameter modification methods by multiplying the design parameter modification amount for each of the plurality of design parameter modification methods calculated by the modification amount calculation part 113 by the development cost coefficient for each of the plurality of design parameter modification methods acquired by the cost coefficient acquisition part 115.

The modification method specification part 117 specifies the design parameter modification method that minimizes the modification cost value calculated by the modification cost calculation part 116 as the optimum design parameter modification method.

Subsequently, a design parameter optimization process of the information processing device 1 in the embodiment of the present disclosure will be described.

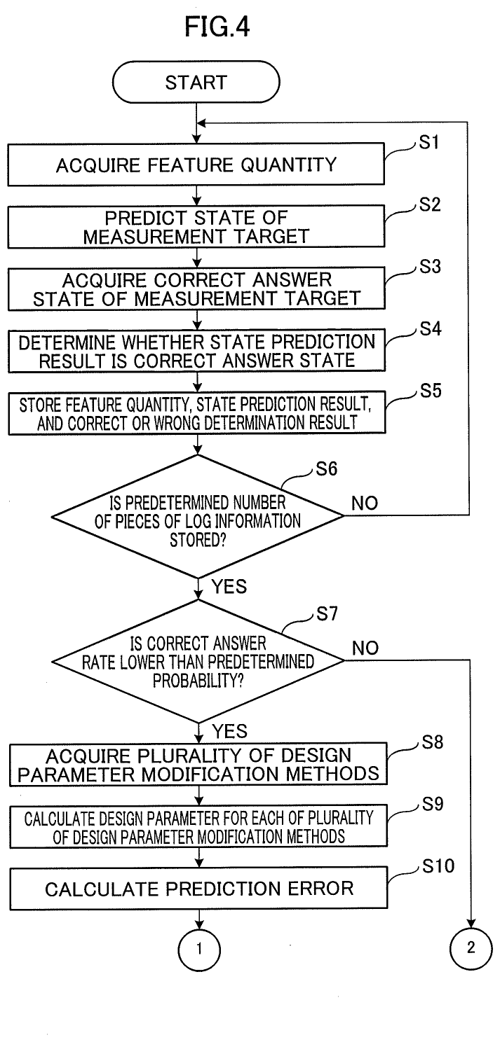

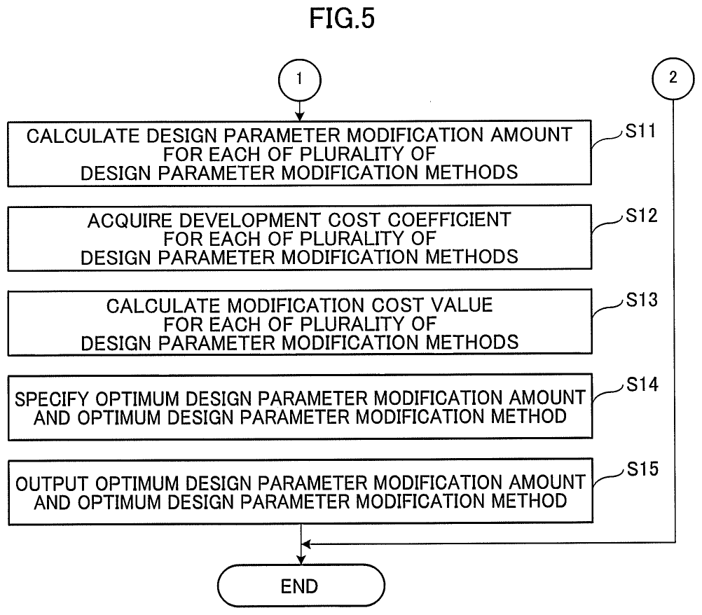

FIG. 4 is a first flowchart for describing the design parameter optimization process of the information processing device 1 in the embodiment of the present disclosure. FIG. 5 is a second flowchart for describing the design parameter optimization process of the information processing device 1 in the embodiment of the present disclosure.

To begin with, in step S1, the feature quantity acquisition part 101 acquires the feature quantity indicating the feature of the measurement target measured by the sensor 2.

Next, in step S2, the state prediction part 102 predicts the state of the measurement target by inputting the feature quantity acquired by the feature quantity acquisition part 101 into the pre-trained machine learning model.

Next, in step S3, the correct answer state acquisition part 103 acquires the correct answer state of the measurement target corresponding to the feature quantity input into the machine learning model.

Next, in step S4, the prediction result determination part 104 determines whether the state prediction result is the correct answer state based on the state prediction result predicted by the state prediction part 102 and the correct answer state acquired by the correct answer state acquisition part 103.

Next, in step S5, the prediction result determination part 104 stores, in the log storage part 105, the feature quantity acquired by the feature quantity acquisition part 101, the state prediction result predicted by the state prediction part 102, and a correct or wrong determination result of the prediction result determined by the prediction result determination part 104 in association with one another.

Next, in step S6, the modification method acquisition part 107 determines whether a predetermined number of pieces of log information is stored in the log storage part 105.

Here, when it is determined that the predetermined number of pieces of log information is not stored in the log storage part 105 (NO in step S6), the process returns to step S1.

Meanwhile, when it is determined that the predetermined number of pieces of log information is stored in the log storage part 105 (YES in step S6), in step S7, the modification method acquisition part 107 determines whether a correct answer rate indicating the probability that the state prediction result is the correct answer state is lower than a predetermined probability.

Here, when it is determined that the correct answer rate is equal to or higher than the predetermined probability (NO in step S7), the process ends.

Meanwhile, when it is determined that the correct answer rate is lower than the predetermined probability (YES in step S7), in step S8, the modification method acquisition part 107 acquires the plurality of design parameter modification methods according to the sensor 2 from the modification method storage part 106.

Note that in the present embodiment, it is determined whether the correct answer rate is lower than the predetermined probability, and when it is determined that the correct answer rate is lower than the predetermined probability, the plurality of design parameter modification methods is acquired, but the present disclosure is not particularly limited to this example. The log information stored in the log storage part 105 may be presented to the user (developer), and an instruction input made by the user who has checked the log information to execute the design parameter optimization process may be accepted.

Next, in step S9, the parameter calculation part 111 calculates the design parameter for each of the plurality of design parameter modification methods.

Next, in step S10, the prediction error calculation part 112 calculates the prediction error indicating the distance between a wrong answer point on the feature quantity space of the feature quantity corresponding to the prediction result determined not to be the correct answer state by the prediction result determination part 104, and a correct answer point on the feature quantity space of the feature quantity corresponding to the prediction result determined to be the correct answer state by the prediction result determination part 104.

Next, in step S11, the modification amount calculation part 113 calculates the design parameter modification amount for each of the plurality of design parameter modification methods on the design parameter space based on the prediction error calculated by the prediction error calculation part 112 and the design parameter calculated by the parameter calculation part 111.

Next, in step S12, the cost coefficient acquisition part 115 acquires the development cost coefficient for each of the plurality of design parameter modification methods from the cost coefficient storage part 114.

Next, in step S13, the modification cost calculation part 116 calculates the modification cost value for each of the plurality of design parameter modification methods by multiplying the design parameter modification amount for each of the plurality of design parameter modification methods calculated by the modification amount calculation part 113 by the development cost coefficient for each of the plurality of design parameter modification methods acquired by the cost coefficient acquisition part 115.

Next, in step S14, among the design parameter modification amounts for the plurality of design parameter modification methods, the modification method specification part 117 specifies the design parameter modification amount that minimizes the modification cost value calculated by the modification cost calculation part 116 as the optimum design parameter modification amount, and specifies the design parameter modification method corresponding to the optimum design parameter modification amount as the optimum design parameter modification method.

Next, in step S15, the modification method output part 109 outputs, to the presentation part 4, the optimum design parameter modification amount and optimum design parameter modification method specified by the modification method specification part 117. The presentation part 4 presents the optimum design parameter modification amount and the optimum design parameter modification method output by the modification method output part 109 to the user (developer).

In this way, from among the plurality of design parameter modification methods to improve the state prediction accuracy of the machine learning model and modify the sensor design parameter, the optimum design parameter modification method is determined, and the determined optimum design parameter modification method is output. Therefore, the design of the sensor 2 is modified by the developer of the sensor 2 by using the output optimum design parameter modification method, thereby enabling the feature quantity input into the machine learning model to be optimized. In addition, the machine learning model is trained using the optimized feature quantity, thereby improving the accuracy of the machine learning

Note that in the present embodiment, the presentation part 4 presents, to the user (developer), the optimum design parameter modification amount and the optimum design parameter modification method that minimize the modification cost value, but the present disclosure is not particularly limited to this example. The presentation part 4 may further present, to the user (developer), the design parameter modification amount and the design parameter modification method that have the second lowest modification cost value, and may further present, to the user (developer), the design parameter modification amount and the design parameter modification method that have the third lowest modification cost value. In addition, the presentation part 4 may further present the feature quantity of the modification target and the state of the modification target, in addition to the optimum design parameter modification amount and the optimum design parameter modification method.

Here, a method for determining the optimum design parameter modification method by the modification method determination part 108 will be described.

To begin with, the design parameter ξ is calculated by the following method.

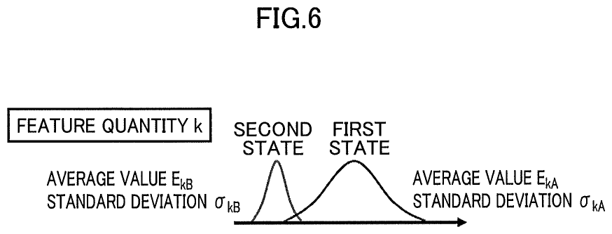

FIG. 6 is a schematic diagram for describing calculation of the design parameter in the present embodiment.

The parameter calculation part 111 classifies each feature quantity of each state (class) of the learning data and calculates two design parameters: the average value and the standard deviation of each distribution. The design parameter ξ is the average value and the standard deviation of the plurality of feature quantities in a plurality of states (classes). Therefore, the design parameter ξ takes the form of a vector of a length of the number of states * number of feature quantities * number of design parameters (two items: average value and standard deviation). In FIG. 6, the parameter calculation part 111 calculates the average value E_{kA} and the standard deviation σ_{kA} of the distribution of the feature quantity k in the first state, and the average value E_{kB} and the standard deviation σ_{kB} of the distribution of the feature quantity k in the second state.

Next, the prediction error ε(On) is calculated by the following method.

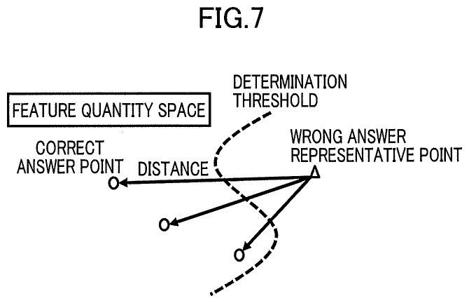

FIG. 7 is a schematic diagram for describing calculation of the prediction error in the present embodiment.

The prediction error calculation part 112 extracts a plurality of records that is incorrectly determined in the state prediction of the machine learning model. The prediction error calculation part 112 selects the record with the smallest probability value of the incorrectly determined state class from among the plurality of extracted records, and sets the record to a wrong answer representative point. Next, the prediction error calculation part 112 extracts a plurality of records that is determined to be correct answer from among the records of the same state class as the wrong answer representative point, and sets the record to the correct answer point. In FIG. 7, the triangular dot represents the wrong answer representative point and the circular dot represents the correct answer point. There is a determination threshold for the machine learning model between the wrong answer representative point and the correct answer point.

The prediction error calculation part 112 calculates, as a prediction error ¿ (On), the distance between each correct answer point of the plurality of extracted records and the wrong answer representative point on the feature quantity space. On denotes the learning parameter for the machine learning model, and (On) denotes the prediction error for the machine learning model when the learning parameter is 0. The prediction error ε(On) takes the form of a vector with a plurality of distance values.

Next, the design parameter modification amount Δξ is calculated by the following method.

The modification amount calculation part 113 calculates the design parameter modification amount Δξ required to acquire the learning data to improve the prediction accuracy based on the following formula (1).

$$Δ ξ = \partial ε ( θ n ) / \partial ξ \qquad ( 1 )$$

In the above formula (1), Δξ denotes the design parameter modification amount, and § denotes the design parameter. Note that the modification method determination part 108 performs calculations with the learning parameter fixed. Therefore, in formula (1), the learning parameter 0 is fixed to On after n updates, that is, after sufficient optimization for the machine learning model is performed. The modification amount calculation part 113 converts ¿ (On), which is the distance on the feature quantity space, into the design parameter modification amount Δξ, which is the distance on the design parameter space by partially differentiating the prediction error ε(θn) with respect to the design parameter ξ. The design parameter modification amount Δξ is the value obtained by partially differentiating ε(θn) with respect to ξ. Therefore, the design parameter modification amount Δξ is expressed as a matrix with the same number of rows as the length of ε(θn) and the same number of columns as the length of ξ.

Next, the modification cost value C(Δξ) is calculated by the following method.

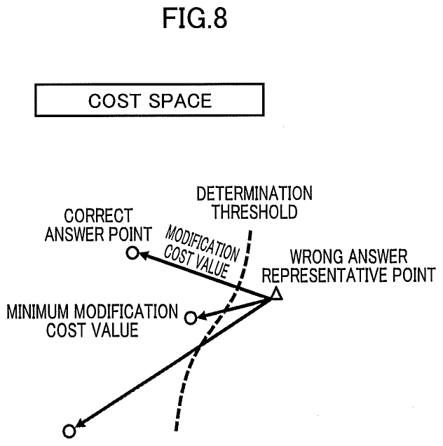

FIG. 8 is a schematic diagram for describing calculation of the modification cost value in the present embodiment.

The modification cost calculation part 116 calculates the modification cost value C(Δξ) for the design parameter modification amount Δξ based on the following formula (2).

$$C ( Δ ξ ) = Δξ * κ \qquad ( 2 )$$

In the above formula (2), K is the development cost coefficient, and C(Δξ) is the modification cost value. The development cost coefficient k is set for each design parameter modification method. Therefore, κ is a vector of the same length as ξ. C(Δξ), which is obtained by multiplying the matrix Δξ by κ, is a vector of the same length as ε(θn). The calculation of above formula (2) shows that the design parameter modification amount Δξ, which is the distance on the design parameter space, is converted into the modification cost value C(Δξ), which is the distance on the cost space.

Finally, the modification method specification part 117 calculates a solution for the optimum design parameter modification method based on the following formula (3).

$$[ Formula 1 ]$$

$$Δ {ξ}_{m i n} = arg {min}_{Δ ξ} ( C ( Δξ ) ) \qquad ( 3 )$$

In the above formula (3), Δξmin is the design parameter modification amount that minimizes the modification cost value C(Δξ). The modification method specification part 117 specifies the design parameter modification amount that minimizes the modification cost value C(Δξ) as the optimum design parameter modification amount. In addition, the modification method specification part 117 specifies the design parameter modification method corresponding to the design parameter modification amount that minimizes the modification cost value C(Δξ) as the optimum design parameter modification method.

As shown in FIG. 8, the distance between the wrong answer representative point and the correct answer point in the cost space corresponds to the modification cost value. The modification method specification part 117 specifies the design parameter modification amount that minimizes the modification cost value indicating the distance between the wrong answer representative point and the correct answer point in the cost space as the optimum design parameter modification amount.

From the above calculations, the design parameter modification amount that minimizes the development cost required for the development of the sensor is calculated, and the design parameter modification method that minimizes the development cost is specified. Then, the developer makes design changes to the sensor 2 based on the above calculation results, thereby making it possible to make design changes to the sensor 2 that can acquire learning data that improves discrimination accuracy with the minimum development cost.

Subsequently, an experiment to confirm the effectiveness of the design parameter optimization process of the information processing device 1 in the embodiment of the present disclosure will be described.

In this experiment, the design parameter modification method to acquire the learning data that further enhances the state prediction accuracy of the machine learning model is specified.

In this experiment, dummy data corresponding to the measurement data of the sensor under development will be used. The sensor has a plurality of channels, and the state prediction performed by the machine learning is a supervised class classification problem.

Since the design parameter optimization process needs state prediction error data for the machine learning model, the machine learning model using the data acquired by the sensor as the learning data is prepared in advance. At this time, the state prediction result is intentionally made to include some errors. It is assumed that the design parameter optimization process is performed based on this state prediction error data, and that design changes to the sensor are made according to the processing results that minimize the development cost, and initial data acquired from the sensor is processed to create the data acquired from the sensor after the design change. The data acquired from the sensor after the design changes is used as the learning data to perform machine learning again, and when it is confirmed that the prediction accuracy of the machine learning model has improved, the design parameter optimization process is demonstrated to successfully specify the design parameter modification method that can acquire learning data to enhance the state prediction accuracy as expected.

In addition, in the above experiment, the development cost coefficient is set according to a plurality of conditions, and when it is confirmed that the results of the design parameter optimization process under each condition are in line with the set condition, the design parameter optimization process is demonstrated to successfully specify the design parameter modification method that reflects the condition of the development cost as expected.

In this experiment, the Iris dataset was used as dummy data for the measurement data acquired from the sensor under development. The Iris dataset is table data having 150 records, with four feature quantities and three flower type classes. The three flower type classes of the Iris dataset are regarded as the state of the measurement target to be predicted, and the four feature quantities are regarded as four-channel signals of the sensor. The four feature quantities include sepal length, sepal width, petal length, and petal width. The three flower type classes include setosa, versicolor, and virginica.

The machine learning model required for the design parameter optimization process was created using the light gradient boosting machine (GBM). The created machine learning model was created to incorrectly determine only one record out of 150 records. At this time, the flower type class of the correct answer was “versicolor,” while the incorrectly determined flower type class was “virginica.”

In this experimental data, the number of sensor design parameters is the number of classes (states) * the number of feature quantities * the number of distribution characteristic values of the feature quantity (average value and standard deviation). Therefore, there are 3 (number of classes)*4(number of feature quantities)*2(number of distribution characteristic values)=24 types of sensor design parameters.

There are also 24 development cost coefficients, which is the same number as the sensor design parameters. In addition, different development cost coefficients are set for a plurality of conditions.

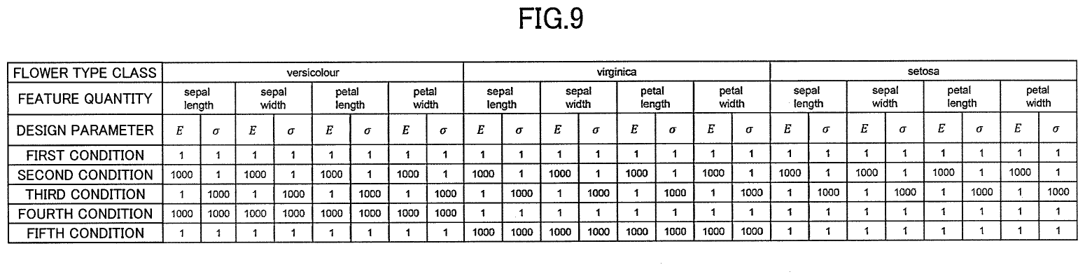

FIG. 9 is a diagram showing one example of flower type classes, feature quantities, design parameters, and development cost coefficients in this experiment. In the design parameters in FIG. 9, E denotes the average value, and σ denotes the standard deviation.

In this experiment, a plurality of sensor development environments is assumed, and the development cost coefficients with some values increased are prepared such that the development cost coefficients are weighted to suit the development environments. The plurality of conditions for the development cost coefficients is as follows.

First condition: All the development cost coefficients are uniform (no weighting).

Second condition: The development cost coefficient related to the average value is weighted.

Third condition: The development cost coefficient related to the standard deviation is weighted.

Fourth condition: The development cost coefficient related to the flower type class of the correct answer including incorrectly determined records (versicolor) is weighted.

Fifth condition: The development cost coefficient related to the determination result class of the incorrectly determined record (virginica) is weighted.

In the first condition, the development cost coefficients of all the average values E and the standard deviations σ are set to 1. In the second condition, the development cost coefficient of the average value E is set to 1000, whereas the development cost coefficient of the standard deviation σ is set to 1. In the third condition, the development cost coefficient of the average value E is set to 1, whereas the development cost coefficient of the standard deviation σ is set to 1000. In the fourth condition, the development cost coefficients of the average value E and the standard deviation σ of versicolor are set to 1000, whereas the development cost coefficients of the average value E and the standard deviation σ of other flower type classes are set to 1. In the fifth condition, the development cost coefficients of the average value E and the standard deviation σ of virginica are set to 1000, whereas the development cost coefficients of the average value E and the standard deviation σ of other flower type classes are set to 1.

In the above first condition to the fifth condition, the design parameter optimization process was performed and the design parameter modification method that minimizes the modification cost value was specified.

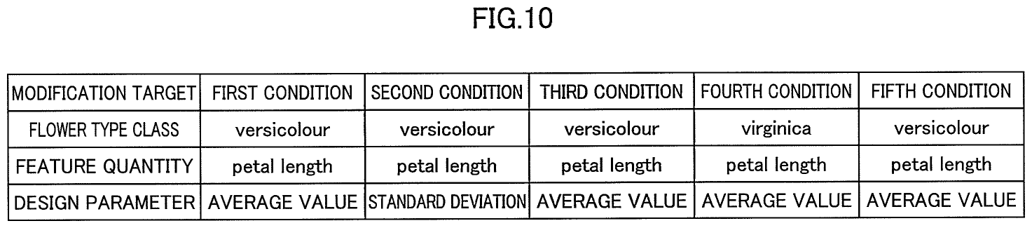

FIG. 10 is a diagram showing one example of the design parameter modification method based on results of the design parameter optimization process in the first condition to the fifth condition.

In the development cost coefficients of the first condition, the third condition, and the fifth condition, the flower type class of the modification target was versicolor, the feature quantity of the modification target was petal length, and the design parameter of the modification target was the average value. In the development cost coefficient of the second condition, the flower type class of the modification target was versicolor, the feature quantity of the modification target was petal length, and the design parameter of the modification target was the standard deviation. In the development cost coefficient of the fourth condition, the flower type class of the modification target was virginica, the feature quantity of the modification target was petal length, and the design parameter of the modification target was the average value.

When the learning data was processed and then the machine learning was performed again based on the design parameter modification method that minimizes the modification cost value for each of the first condition to the fifth condition shown in FIG. 10, the incorrect determination of the state prediction was resolved in all the learning data after the change. From this result, it was confirmed that the design parameter modification method specified in the design parameter optimization process has been changed to sensor design that can acquire the learning data that improves the prediction accuracy.

From the experimental results, the design parameter modification method was identical in the first condition, the third condition, and the fifth condition. This is because the first condition is the design parameter modification method specified under the condition that the development cost coefficient is not weighted and the design parameter listed there does not include items weighted in the third condition and the fifth condition. In the design parameter other than the design parameters weighted in the third condition and the fifth condition, the design parameter that minimizes the modification cost value is found. Therefore, it is considered that the weighting in the third condition and the fifth condition does not affect the selection of the design parameter modification method that minimizes the modification cost value, and that results in the third condition and the fifth condition are the same as results in the first condition.

Meanwhile, the results in the second condition and the fourth condition differed from the results in the first condition. This is because, since the design parameters weighted in the second condition and the fourth condition are included in the calculation results in the first condition, it is considered in the second condition and the fourth condition that the weighted design change items are excluded as being too costly and that another design parameter modification method is selected as the design parameter modification method that minimizes the modification cost value.

From this result, it was confirmed that the design parameter optimization process can specify the design parameter modification method that reflects the first condition to the fifth condition of the development cost coefficient.

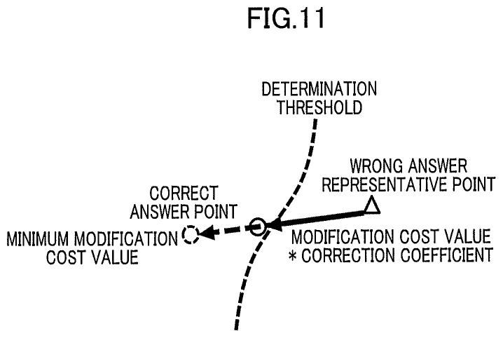

FIG. 11 is a schematic diagram for describing calculation of the modification cost value in a modified example of the present embodiment.

In the present embodiment, the modification method specification part 117 specifies the design parameter modification amount that minimizes the modification cost value indicating the distance between the wrong answer representative point and the correct answer point in the cost space as the optimum design parameter modification amount. Here, as shown in FIG. 11, there is a determination threshold for the machine learning model between the wrong answer representative point and the correct answer point. Therefore, if an arrow is extended from the wrong answer representative point to the correct answer point where the modification cost value is the smallest, the arrow will exceed the determination threshold on the way. Therefore, the modification method specification part 117 in the modified example of the present embodiment may multiply the modification cost value by a correction coefficient whose magnitude does not exceed the determination threshold, repeat state predictions while gradually increasing the correction coefficient, and search for the correction coefficient value at which the determination result of the machine learning model switches.

More specifically, the modification method determination part 108 may further include a correction coefficient multiplication part that multiplies the modification cost value for each of the plurality of design parameter modification methods calculated by the modification cost calculation part 116 by the correction coefficient. The modification method specification part 117 may specify the design parameter modification method that minimizes the modification cost value multiplied by the correction coefficient as the optimum design parameter modification method. Then, the state prediction part 102 may predict the state of the measurement target by inputting the feature quantity obtained from the sensor 2 using the design parameter modified by the optimum design parameter modification method specified by the modification method specification part 117 into the machine learning model. The prediction result determination part 104 may determine whether the state prediction result is the correct answer state based on the state prediction result predicted by the state prediction part 102 and the correct answer state corresponding to the feature quantity input into the machine learning model. The modification method determination part 108 may further include an update part that updates the correction coefficient when it is determined by the prediction result determination part 104 that the state prediction result is not the correct answer state. At this time, the update part updates the correction coefficient to be higher than the current correction coefficient. The update part repeats updating of the correction coefficient until it is determined that the state prediction result is the correct answer state, thereby making it possible to further suppress the development cost.

Note that in each of the embodiments, each component may include dedicated hardware or may be implemented by execution of a software program suitable for each component. Each component may be implemented by a program execution unit, such as a central processing unit (CPU) or a processor, reading and executing a software program recorded in a recording medium such as a hard disk or a semiconductor memory. The program may be executed by another independent computer system by being recorded in a recording medium and transferred or by being transferred via a network.

Some or all functions of the devices according to the embodiment of the present disclosure are implemented as large scale integration (LSI), which is typically an integrated circuit. These functions may be individually integrated into one chip, or may be integrated into one chip so as to include some or all functions. Circuit integration is not limited to LSI, and may be implemented by a dedicated circuit or a general-purpose processor. A field programmable gate array (FPGA), which can be programmed after manufacturing of LSI, or a reconfigurable processor in which connection and setting of circuit cells inside LSI can be reconfigured may be used.

Some or all functions of the devices according to the embodiment of the present disclosure may be implemented by a processor such as a CPU executing a program.

The numerical figures used above are all illustrated to specifically describe the present disclosure, and the present disclosure is not limited to the illustrated numerical figures.

The order in which each step illustrated in the above flowcharts is performed is for specifically describing the present disclosure, and may be an order other than the above order as long as a similar effect can be obtained. Some of the above steps may be executed simultaneously (in parallel) with other steps.

The technology according to the present disclosure, which can optimize the feature quantity input into the machine learning model, is useful as a technology to optimize design parameters for developing sensors.

1. An information processing method in a computer, the information processing method comprising:
acquiring a feature quantity indicating a feature of a measurement target measured by a sensor;
predicting a state of the measurement target by inputting the feature quantity into a machine learning model;
acquiring a plurality of design parameter modification methods to improve state prediction accuracy of the machine learning model and modify a design parameter of the sensor;
determining an optimum design parameter modification method from among the plurality of design parameter modification methods based on the feature quantity and a prediction result of the state; and
outputting the optimum design parameter modification method determined.

2. The information processing method according to claim 1, wherein
determining the optimum design parameter modification method includes:
calculating a modification amount of the design parameter for each of the plurality of design parameter modification methods based on the feature quantity and the prediction result of the state; and
specifying the optimum design parameter modification method from among the plurality of design parameter modification methods based on the modification amount.

3. The information processing method according to claim 2, further comprising determining, based on the prediction result of the state and a correct answer state corresponding to the feature quantity input in the machine learning model, whether the prediction result of the state is the correct answer state wherein determining the optimum design parameter modification method further includes:
calculating the design parameter for each of the plurality of design parameter modification methods; and
calculating, as a prediction error, a distance between a wrong answer point of the feature quantity corresponding to the prediction result determined not to be the correct answer state on a feature quantity space, and a correct answer point of the feature quantity corresponding to the prediction result determined to be the correct answer state on the feature quantity space, and
calculating the modification amount of the design parameter includes calculating the modification amount on the design parameter space based on the calculated prediction error and the calculated design parameter.

4. The information processing method according to claim 2, wherein
determining the optimum design parameter modification method further includes:
acquiring a development cost coefficient that is set for each of the plurality of design parameter modification methods and is set according to a cost required to develop the sensor; and
calculating a modification cost value for each of the plurality of design parameter modification methods by multiplying the modification amount for each of the plurality of design parameter modification methods by the development cost coefficient for each of the plurality of design parameter modification methods, and
specifying the optimum design parameter modification method includes specifying the design parameter modification method that minimizes the modification cost value calculated as the optimum design parameter modification method.

5. The information processing method according to claim 4, wherein
determining the optimum design parameter modification method further includes multiplying the modification cost value for each of the plurality of design parameter modification methods by a correction coefficient,
specifying the optimum design parameter modification method includes specifying the design parameter modification method that minimizes the modification cost value multiplied by the correction coefficient as the optimum design parameter modification method,
predicting the state includes: predicting the state of the measurement target by inputting the feature quantity obtained from the sensor using the design parameter modified by the specified optimum design parameter modification method into the machine learning model; and
determining whether the prediction result of the state is the correct answer state based on the prediction result of the state and the correct answer state corresponding to the feature quantity input into the machine learning model, and
determining the optimum design parameter modification method further includes updating the correction coefficient when it is determined that the prediction result of the state is not the correct answer state.

6. The information processing method according to claim 1, wherein
the design parameter is an average value of distribution of the feature quantity, and
the design parameter modification method shifts the average value of the distribution of the feature quantity.

7. The information processing method according to claim 1, wherein
the design parameter is a standard deviation of distribution of the feature quantity, and
the design parameter modification method shrinks the standard deviation of the distribution of the feature quantity.

8. An information processing device comprising:
a feature quantity acquisition part that acquires a feature quantity indicating a feature of a measurement target measured by a sensor;
a prediction part that predicts a state of the measurement target by inputting the feature quantity into a machine learning model;
a modification method acquisition part that acquires a plurality of design parameter modification methods to improve state prediction accuracy of the machine learning model and modify a design parameter of the sensor;
a modification method determination part that determines an optimum design parameter modification method from among the plurality of design parameter modification methods based on the feature quantity and a prediction result of the state; and
an output part that outputs the optimum design parameter modification method determined.

9. A non-transitory computer readable recording medium storing an information processing program that causes a computer to execute:
acquiring a feature quantity indicating a feature of a measurement target measured by a sensor;
predicting a state of the measurement target by inputting the feature quantity into a machine learning model;
acquiring a plurality of design parameter modification methods to improve state prediction accuracy of the machine learning model and modify a design parameter of the sensor;
determining an optimum design parameter modification method from among the plurality of design parameter modification methods based on the feature quantity and a prediction result of the state; and
outputting the optimum design parameter modification method determined.
